(19) United States
(12) Patent Application Publication
(10) Pub. No.: US 2009/0173822 A1
(43) Pub. Date: Jul. 9, 2009

(54) Distributed infrared countermeasure installation for fixed wing aircraft

(76) Inventors: Arnold Kravitz, Moorestown, NJ (US); George J. Hoff, Mont Vernon, NH (US); Martin Raab, Amherst, NH (US); Donald K. Smith, Rye, NH (US); James Rusch, Hollis, NH (US); John Ferrari, Nashua, NH (US); Christopher L. Chew, Litchfield, NH (US)

Correspondence Address: BAE SYSTEMS, PO BOX 868, NASHUA, NH, 03061-0868, US

(21) Appl. No.: 12/228,510

(22) Filed: Aug. 11, 2008

Related U.S. Application Data
(60) Provisional application No. 61/010,314, filed on Jan. 7, 2008.

(51) Int. Cl. B64D 45/00

(52) U.S. Cl. 244/1 R

(57) ABSTRACT

A distributed aircraft defense system involving infrared countermeasures is installed in a distributive fashion for commercial aircraft, typically fixed wing aircraft, in which maintenance downtime is minimized due to the ability to access, remove, test, fix and/or replace individual modules within the distributed system.

### CROSS REFERENCE TO RELATED APPLICATION

This Application claims rights under 35 USC § 119(e) from U.S. application Ser. No. 61/010,314 filed Jan. 7, 2008, the contents of which are incorporated herein by reference.

### STATEMENT OF GOVERNMENT INTEREST

This invention was made with United States Government assistance under Other Transactional Agreement No. HSSCHQ-04-C-00342 awarded by the Department of Homeland Security. The United States Government has certain rights in this invention.

### FIELD OF THE INVENTION

This invention relates to the provision of commercial aircraft with an airliner defense system and more particularly to a distributed infrared countermeasure system for deployment on airliners which leads to minimized maintenance downtime in the commercial airline environment.

### BACKGROUND OF THE INVENTION

After the attempt to ground a civilian commercial aircraft in Mombasa, Kenya in November 2002, the Department of Homeland Security promulgated out a request for potential solutions to protect commercial aircraft from missiles fired from the ground, namely shoulder fired missiles commonly referred to as Man Portable Air Defense System (MANPADS). MANPADS refers to a human launching pad for such ground-to-air missiles. Two primary defeat techniques were proposed, namely a laser-based jamming technique and one which dispenses chaff to confuse the incoming missile.

As to laser-based jammers, existing military products proved not to be suitable for commercial aviation. This is because there are various factors which present a challenge as how to adapt the military technology to a commercial environment. As will be appreciated, commercial airlines fly anywhere and do not maintain maintenance crews at every place they fly to.

Moreover, commercial aircraft have to be turned quickly, oftentimes in a matter of thirty minutes. The commercial aircraft industry cannot tolerate downtime, especially with the financial constraints that plague the airline industry.

Thus, the economics of providing commercial aircraft with air defense systems vary significantly from the military model where one has trained maintainers at every operating location. Also, in a military situation one has trained pilots and has security measures in place at every position where the aircraft lands or takes off from.

On the other hand, commercial airliners are not restricted and may land anywhere. They are thus maintained on a very intermittent basis. As an example, military systems typically run at a meantime between failure of about 600 to 1,000 hours which are considered quite good numbers. However, in the commercial embodiment, meantime to failure of 10,000 to 20,000 hours are considered to be good numbers.

Moreover, military systems were designed for two-level maintenance. The first level of maintenance is on the flight line, and the second is maintenance back at a depot. These two-level maintenance scenarios are analogous to the commercial model.

However, the part that is not analogous to the military model is the fact that in a military situation one has trained maintenance personnel at every operating point who can diagnose what has failed and fix it or replace it. Note that any part of the aircraft defense system which has moving parts is susceptible to failure and a failure mode higher than pure electronic boxes.

Moreover, lasers themselves, the pointer tracker, which is the device that aims the laser beam that includes gimbals are devices which are most likely to fail. Note also that the conventional pointer tracker includes a cryogenic cooler, which also has a high propensity to fail.

It is therefore important that these items be configured so as not to have such a high failure rate, or at least be configured so that the schedule for maintenance is considerably longer than that associated with military aircraft.

It is, of course, a good deal easier to maintain military aircraft which do not fly long distances on a regular basis. On the other hand, commercial airliners often go coast to coast as a matter of course. As will be appreciated, the military often, when flying long distances, breaks up the flight into a number of different flights, sometimes as many as eleven or twelve.

For commercial aircrafts, it is necessary to maintain and quickly replace failed components in the field, not at a military base or installation at which highly skilled performance are located. Thus the use of suitable simple maintenance at commercial airports is critical to airlines but not as important to the military.

One of the solutions for providing a commercial aircraft with an airliner defense capability is shown in U.S. Patent Application Publication No. US2005/0029394, which involves a conformal airliner defense system in the nature of a pod which is attached to the underbelly of an aircraft. Typically the large pod on a commercial airlines vehicle is roughly 300 pounds and involves a 9 foot long canoe that is bolted to the bottom of the aircraft.

For any maintenance, the pod must be shipped back to a depot where it is to be repaired. This is a very complicated process, because the handling of a 300 pound pod requires special handling equipment.

Moreover, it is very unlikely that everything within the pod will fail at once, and thus demounting the pod to remove and replace failed components or shipping it back to a depot impacts the maintenance downtime considerably.

Typically in an IRCM system all of the components will not fail at once. For instance, in one typical application, there are four warning sensors, a central computer, a laser, a pointer tracker and a pointer tracker electronics box with four warning sensors. This constitutes eight separate boxes, all of which have differing failure rates and which are liable to fail at random times.

Note that with a pod approach one at the very least has to drop the whole pod off of the aircraft, obtain access to the inside of the pod, and take bits and pieces out of the pod to find out which one has failed. As will be appreciated, this maintenance regime does not work in a commercial aviation environment.

### SUMMARY OF THE INVENTION

Rather than utilizing the pod approach for the housing and deployment of an airliner defense system, in the subject invention one utilizes an distributed installation in which each of the boxes or modules are installed individually in the aircraft at appropriate locations, with the sensors and pointer tracker giving the total field of regard coverage over the whole vulnerable zone around the aircraft. As will be appreciated, the distributed system allows each of the boxes or modules to be separately removed and replaced without disturbing any of the other parts of the system.

In one embodiment the largest module is roughly 75 pounds. The warning sensors in one embodiment are 4 pounds a piece, with the central processor being 16 pounds, the pointer tracker being 38 pounds, and the pointer tracker controller being about 14 pounds. All of these are available for removal and inspection by single personnel.

Note that in the distributed system, the individual modules or boxes are separated. For instance, in one embodiment the four sensors are mounted two to a side towards the rear of the aircraft. The two on each side are spaced roughly two feet apart.

The sensors involved are usually UV sensors, which are operated in the UV portion of the electromagnetic spectrum and transmit their information to a central processor which functions as the executive processor to take all the information from the four sensors, determine the characteristics of the imagery that is in their field of view and determines whether or not what is sensed is a real threat or a false alarm. It is of course noted that one wants to key the countermeasures on real threat occurrences and not be off servicing a false alarm.

The system described above is the core of the military's common missile warning system (CMWS). The CMWS operates in the ultraviolet and senses the excited emissions from a rocket motor exhaust. The sensors and the central processor constitute a UV warner to sense the missile as it approaches.

Once the central processor reaches a conclusion that a given level of confidence applies to a potential threat, meaning that a missile is in fact detected as opposed to a false alarm source, a signal is sent from the central processor to instruct the pointer tracker to look at the detected object. It then sends a cuing command to the pointer tracker to slew over to the commanded azimuth and elevation corresponding to the detected target.

The warner sensors spatially separate the incoming threats and convert them to an internal frame such that the system is stabilized as the aircraft moves. The internally stabilized results convert the sensed target location into the pointer tracker reference frame, with the pointer tracker then slewing to the indicated position.

Within the pointer tracker is also an infrared spatial sensor having a focal plane array from which more precise aiming information is obtained.

Upon matching the criteria that what is detected is truly a threat, information is sent back to the central processor which commands the laser to start firing infrared energy, which confuses and defeats the missile.

In order to properly aim the laser, there is a pointer tracker controller which has two software pieces, namely a servo controller and a track processor. Note that the servo controller is a stabilization element that removes all of the platform motion from the gimbals thereby to initially stabilize the pointer platform. Once the infrared tracker has acquired infrared image, the tracker processor tracks the image and moves the pointing gimbals as threat moves to keep the pointer tracker pointed in the direction of the threat as it moves towards the aircraft.

It is the finding of the subject invention that one can distribute the functions of the airliner defense system over the length of the aircraft, because none of the modules have critical matching components to the other of the modules. For instance, one does not have to match the laser to the pointer tracker, and one does not have to match the central processor to the individual sensors. Thus, unlike the pod design, one does not have to place all of the components or modules close together. One certainly does not have to mount the entire system on a common optical bench, but rather can distribute the modules to whatever is a convenient location within the aircraft utilizing the existing aircraft infrastructure, as long as the system has the field of regard that lets one achieve the coverage intended.

It is therefore an important part of this invention that the modules utilized in the airliner defense system have sufficient tolerances to support the distributive architecture such that the individual modules do not have to be matched to each other but rather cooperate with each other due to the tolerances that are specifically designed within the module. Thus all of the modules are designed to talk to each other without specially designed interfaces or critical mechanical interface tolerances.

There is another advantage of the distributed architecture versus the podded approach. In the subject system, since the sensors are mounted directly to the aircraft structure rather than to a pod, they only minimally protrude into the airstream. All of this minimally disturbs the airflow around the aircraft which reduces drag. As will be appreciated, drag translates into fuel consumption, and fuel consumption is paramount with the airline industry insofar as rising fuel prices directly impact operating costs. This minimal protrusion also lessens the probability of damage to either the system or to the multitude of ground handling equipment used in commercial aviation by inadvertent collisions.

Note that the military IRCM systems are usually mounted to helicopters, with the biggest helicopter being perhaps as long as 40 feet in length. However, commercial airliners are between 100-150 feet in length, and one has to make sure that the distributed system can handle that much separation between the individual operating elements.

Moreover, each of the operating elements is designed to be maintained by standard aircraft maintenance technicians using common tools and a built in test program compatible with commercial airlines operating philosophies.

Thus, when going from a podded system to a distributive system, it was indeed a challenge that one could accomplish the distribution because of the many different parts interacting with each other. It is not at all clear that one could push the elements far apart, bury them in the plane and have then operate in a distributed fashion. Because of the large tolerances specifically designed for the modules that have been developed for military IRCM systems, it has been found that these tolerances are more than sufficient to support distribution over the entire commercial aircraft. By being able to do so, one has a system which is quickly maintainable in the field by the type of personnel that airlines employ at even the remotest of airports.

In summary, a distributed aircraft defense system involving infrared countermeasures is installed in a distributive fashion for commercial aircraft, typically fixed wing aircraft, in which maintenance downtime is minimized due to the ability to access, remove, test, fix and/or replace individual modules within the distributed system.

### BRIEF DESCRIPTION OF THE DRAWINGS

These and other features of the subject invention will be better understood in connection with a Detailed Description in conjunction with drawings, of which:

FIG. 1 is a diagrammatic illustration of a prior art belly pod for the protection of a commercial airliner, illustrating the provision of all of the countermeasure components within the rather large pod;

FIG. 2 is a diagrammatic illustration of a low drag, easily maintained distributed IRCM installation, illustrating the position of sensors, a control electronics module including a main processor, a laser, a pointer tracker and a pointer tracker controller;

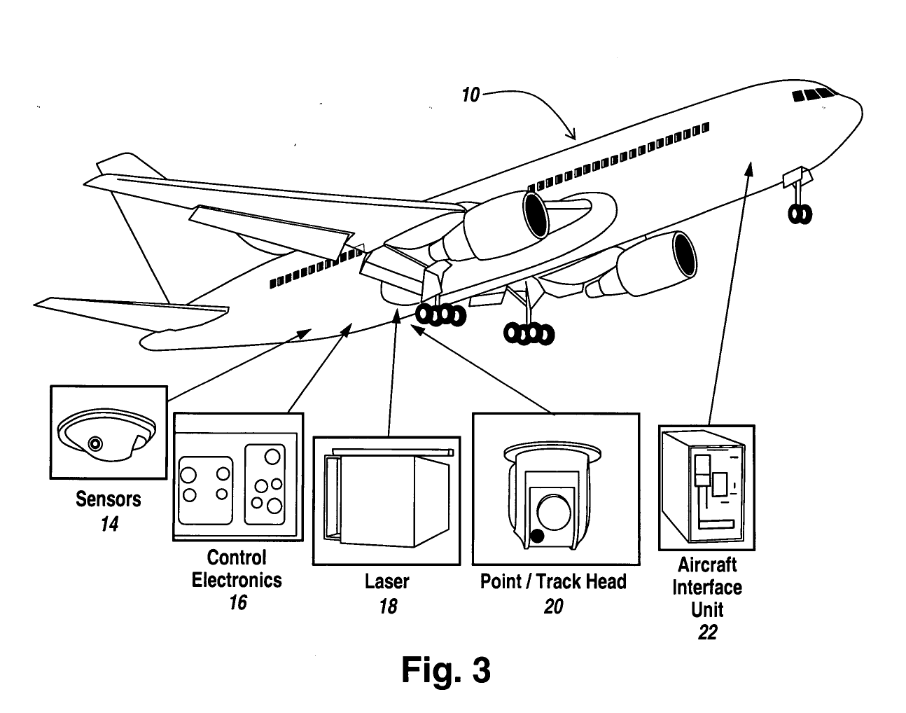

FIG. 3 is a diagrammatic illustration in chart form of the migration of a military system to a commercial environment in which the system is required to be adaptable to more plans, more flight hours, short turnaround times, more sensitivity to costs, more sensitivity to delays, and employs a different market driven infrastructure; and,

FIG. 4 is a diagrammatic illustration of a simple aircraft modification to transition from a clean configuration to a protected configuration involving the convenient mounting of a laser pointer module on the underbelly of the aircraft.

### DETAILED DESCRIPTION

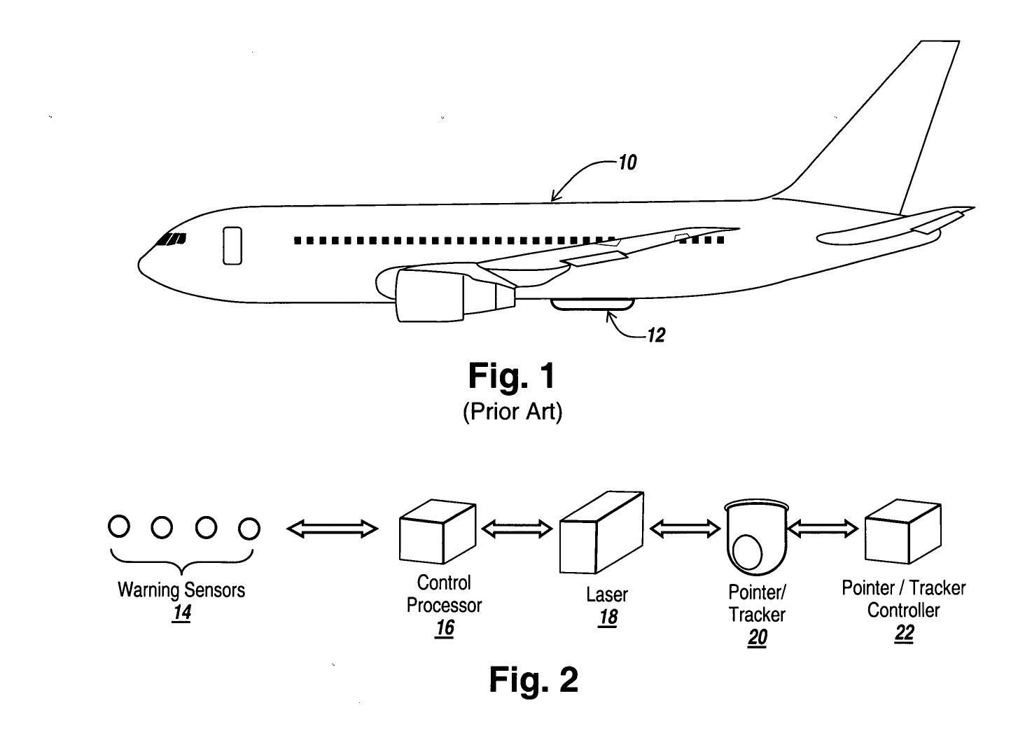

Referring now to FIG. 1, a commercial aircraft 10 is shown being provided with a pod 12 that illustrates the prior art conformal airline defense module that contains a common equipment mounting structure within a canoe shaped cover or aerodynamic housing. The common mounting structure holds all the countermeasure system's components secure and in alignment relative to one another. It is this common mounting structure and the requirement for the secure and rigid alignment of the countermeasure's components makes it impractical to provide a lightweight system in which components can be separately removed and maintained.

In the subject system, which constitutes a distributive system, warning sensors 14 are coupled to a central processor 16, which is in turn coupled to a laser 18 and then to a pointer/tracker 20 that is controlled by a pointer tracker controller 22. Each of these modules are interconnected with other modules, either by a electronics or optical links as illustrated by double ended arrows 24, with the communications making possible the distribution of these modules or boxes throughout aircraft 10 of FIG. 1.

It is noted that each of these modules or boxes is configured to have either electrical or optical outputs with tolerances that establish the interoperability of these components with adjacent components without modification. Thus, the inputs and outputs of the sensors and their coding and transmissions system and compatible with the central processor input and outputs, with the central processor output being compatible to excite laser 18 and to provide coordinates for the pointer tracker, which is in turn coupled to the pointer tracker controller.

It is noted that none of these modules or components are mounted to an optical bench and their alignment one to the other is not maintained by any single mechanical structure. This means that the individual modules can be spaced about the aircraft as desired.

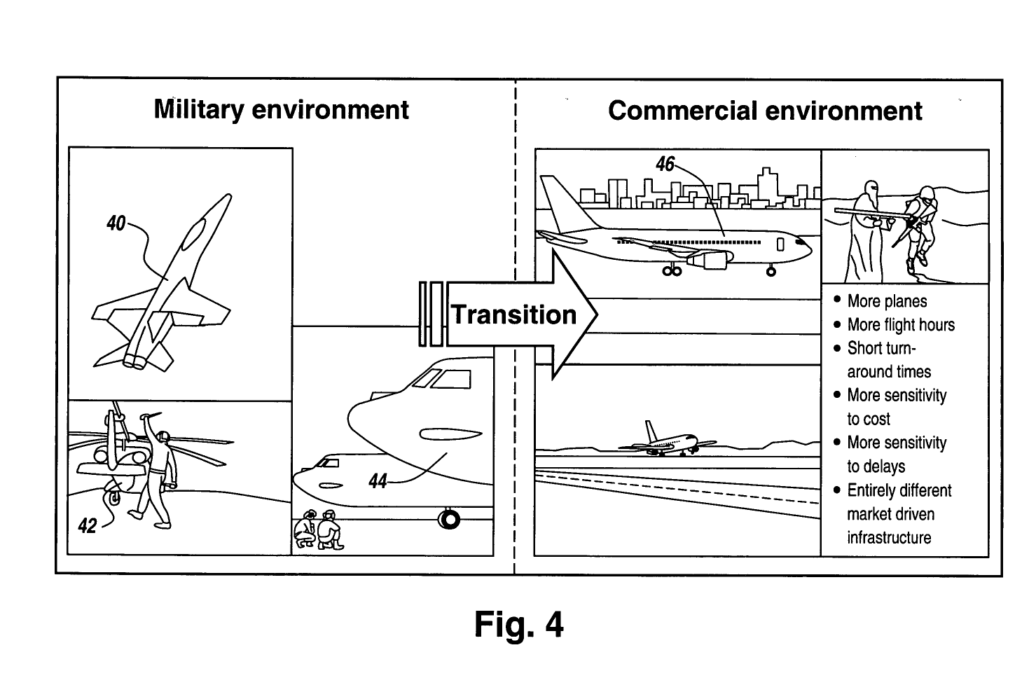

How these modules are physically spaced on a Boeing 767 illustrated in FIG. 3 is now described.

Here, as can be seen, airliner 10 is provided with sensors 14 at the tail section thereof, the sensors being coupled to a central processor within the control electronics 30 located forward of the sensors. Laser 18 is mounted still further within the fuselage laser 18 is coupled to the pointer tracker head 20 which takes the output of the laser and redirects it towards an incoming threat, with the pointer tracker head being the only major component which depends from the clean aircraft fuselage.

The pointer tracker head is in turn controlled by pointer tracker controller 22 within the aircraft interface unit such that the system may be readily maintained through access to the individual boxes or modules. Note these modules are interoperable due to the design intolerances for the inputs and outputs of the various modules.

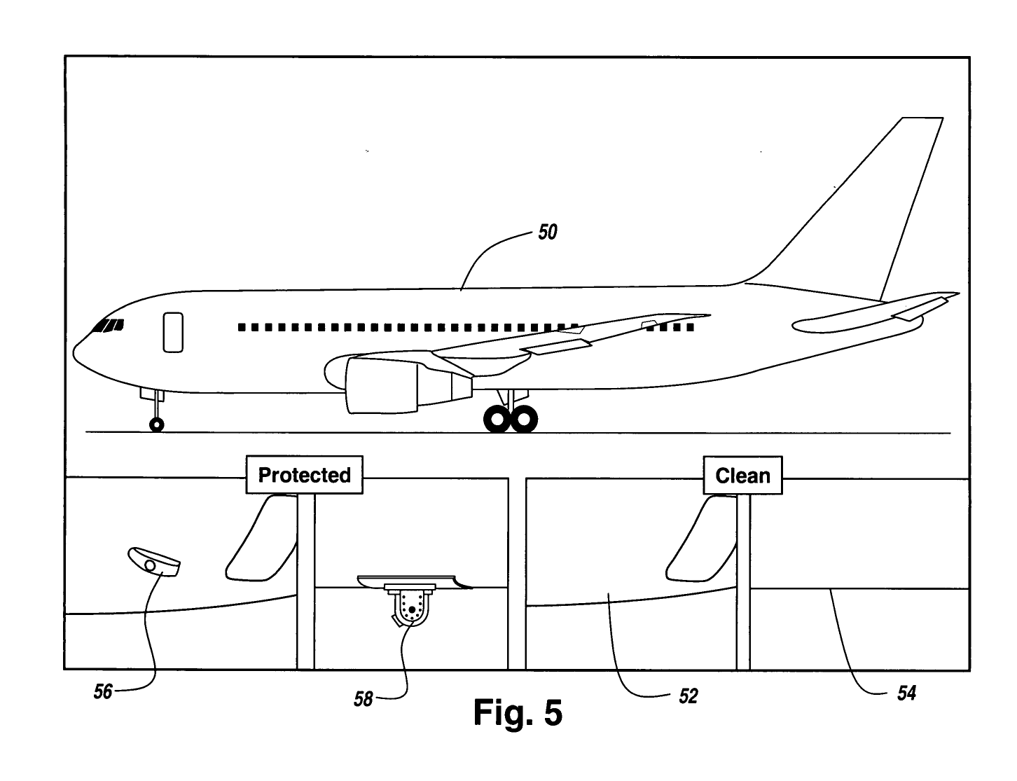

Referring now to FIG. 4, this figure is a diagrammatic illustration showing the migration of military technology to the commercial world in which the military environment is basically comprised of fighter aircraft 40, helicopter aircraft 42, and bombers 44, whereas commercial aircraft 46 involves more planes, more flight hours, short turnaround times, more sensitivity to costs, more sensitivity to delays, and involves an entirely different market driven infrastructure.

Referring now to FIG. 5, a typical commercial airliner 50 is shown in a clean version at 52 and 54 where the skin of the aircraft is unimpeded by any airflow restricting or disturbing appendages.

As can be seen, belly portions 52 and 54 are devoid of protection apparatus, whereas warning sensor 56 and pointer tracker 58 are the only items projecting from the belly of the aircraft to provide protection.

It will be appreciated that the airflow is only minimally impacted by the pointer tracker and is maintainable by simply unbolting it from the belly of the aircraft, with the weight of the pointer tracker being that which can be accommodated manually without specialized equipment.

As will be seen, the subject system incorporates a simple aircraft modification from a clean to a protected configuration which does not impact FAA certification. Most importantly, by use of the distributive system, one can utilize existing maintenance personnel with relatively little expertise to be able to test and maintain the individual modules or boxes that make up the distributive system, with the individual modules or boxes being lightweight and removable without having to remove the entire countermeasure system.

The result is an economical system for protecting commercial aircraft and takes into account the operating conditions of commercial aircraft such that maintenance requirements minimally impact commercial aircraft operations.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for airliner defense comprising:
A distributed aircraft defense system having modules spaced from one another and located within the aircraft, each of the modules being accessible for maintenance, whereby maintenance may be performed on the aircraft defense system at remote locations, with standard aircraft maintenance personnel and in timeframes commensurate with commercial airline operations.

2. The apparatus of claim 1, wherein said modules have inputs and outputs having input and output tolerances that are designed for broad interoperability, such that the modules may be interconnected without alignment or specialized interfaces.

3. The apparatus of claim 2, wherein said modules are initially designed with broad input and output tolerances.

4. The apparatus of claim 1, wherein said modules are not mechanically aligned one with the other.

5. The method of claim 1, wherein said modules are selected from modules associated with a common missile warning system.

6. The apparatus of claim 5, wherein the common missile warning system includes ultraviolet sensors for sensing the associated emissions from a rocket motor exhaust.

7. The apparatus of claim 1, wherein said modules include at least one of a warning sensor, a control processor, a laser, a laser pointer tracker, and a pointer tracker controller.

8. The apparatus of claim 1, wherein said modules include warning sensors, a control processer, a laser, a pointer tracker, and a pointer tracker controller, each separated one from the other and interconnected without specialized interfaces and without relying on an optical bench.

9. The apparatus of claim 1, wherein each of said modules can be handled by an individual due to the weight thereof.

10. The apparatus of claim 1, wherein said modules include internally carried modules with the exception of a pointer tracker which extends from the fuselage of the aircraft and at least one sensor which extends from the fuselage of the aircraft, whereby turbulent airflow resulting from said aircraft defense system is minimized.

11. A method for defending an airliner against attack by a missile to minimize maintenance downtime comprising:
installing a distributed infrared countermeasure system within the aircraft with the system including a number of modules spaced about the aircraft and accessible by an individual for the maintenance, testing, repair and/or replacement thereof by a single individual without the use of specialized handling equipment.

12. The method of claim 11, wherein the modules are specifically configured with tolerances to assure interoperability with other modules on the system without having to utilize a common rigid mechanical support for all of the modules.

13. The method of claim 12, wherein the modules are distributed throughout the aircraft and are secured without the use of an optical bench.

14. The method of claim 12, wherein said modules include a pointer tracker, which extends from the fuselage of the aircraft and provides only minimal drag, the other modules being solely within the fuselage of the aircraft, with the exception of one or more sensors that protrude from the aircraft a minimal amount.

15. The method of claim 12, wherein the modules include at least one of a warning sensor, a control processor, a laser, a pointer tracker, and a pointer tracker control.

16. The method of claim 15, wherein the modules can be maintained by removal, inspection, repair or replacement by a single individual without the use of specialized handling equipment.

17. The method of claim 12, wherein the use of the distributed system permits limiting the weight of an individual module such that it can be removed, tested, repaired or replaced without the necessity of removal of any of the other modules.

18. A system for defending an aircraft against incoming missiles fired from the ground which is easily maintainable in the field using standard aircraft maintenance personnel, avoiding the use of a pod carried on the belly of the aircraft in which all of the countermeasure equipment is carried in the pod and in which the pod must be removed for maintenance procedures, comprising:
a number of modules distributed throughout the aircraft and spaced from one another, with the modules having input and output tolerances that are designed for broad interoperability and interconnected without alignment or specialized interfaces, the modules being distributed throughout the aircraft and being individually maintainable by either access to or removal of the individual modules, the weight of the modules being maintained below that which can be handled by an individual without specialized handling equipment.

19. The system of claim 18, wherein said modules are selected from modules associated with a common missile warning system.

20. The system of claim 19, wherein said common missile warning system includes ultraviolet sensors for sensing the associated emissions from rocket motor exhaust.

21. The system of claim 18, wherein said modules include at least one of a warning sensor, a control processor, a laser, a laser pointer tracker and a pointer tracker controller.

22. The system of claim 18, wherein said modules include a warning sensor, a control processor, a laser, a pointer tracker and a pointer tracker controller.

23. The system of claim 18, wherein said modules include internally carried modules with the exception of a pointer tracker which extends from the fuselage of the aircraft and at least one sensor which extends from the fuselage of the aircraft, whereby turbulence airflow resulting from said system is minimized.
